(19) United States
(12) Patent Application Publication
(10) Pub. No.: US 2018/0058914 A1
(43) Pub. Date: Mar. 1, 2018

(54) LOAD DETECTING APPARATUS

(71) Applicant: AISIN SEIKI KABUSHIKI KAISHA, Kariya-shi, Aichi (JP)

(72) Inventor: Naoya IESATO, Kariya-shi (JP)

(73) Assignee: AISIN SEIKI KABUSHIKI KAISHA, Kariya-shi, Aichi (JP)

(21) Appl. No.: 15/550,405

(22) PCT Filed: Jun. 7, 2016
(86) PCT No.: PCT/JP2016/066865

§ 371 Date: Aug. 11, 2017

(30) Foreign Application Priority Data
Jun. 8, 2015 (JP) 2015-115890

(51) Int. Cl. G01G 23/02; G01L 1/22; G01L 1/26

(52) U.S. Cl. CPC G01G 23/02; G01L 1/26; G01L 1/22

(57) ABSTRACT

A load detecting apparatus includes a load input portion, a strain body including an annular portion provided with a contact portion being in contact with at least a part of the output surface, the strain body including a support portion supporting the annular portion so as to be swingable, a swing portion swinging in accordance with an input of a load, an extending portion being continuously provided with the swing portion and extending from the support portion, a sensor being disposed at a back surface of a surface in which the contact portion is provided; and a restriction portion being formed at a base end portion of the extending portion relative to the contact portion, the restriction portion restricting a deformation of the annular portion beyond a predetermined value in a case where the load inputted to the load input portion is greater than a preset load.

### TECHNICAL FIELD

The present invention relates to a load detecting apparatus detecting a load.

### BACKGROUND ART

Conventionally, a load detecting apparatus is used for detecting a load inputted to various apparatuses. The load detecting apparatus of this kind is described in Patent references 1 to 3 disclosed sources below.

A load detecting apparatus disclosed in Patent reference 1 includes a cylindrical circumferential wall portion, a disc-shaped disc-shaped portion, a load input portion and a sensor. The disc-shaped portion is formed with a through hole which is coaxially provided with the circumferential wall portion, and is supported at an inner circumferential surface of the circumferential wall portion by having a clearance between the disc-shaped portion and a mounting surface on which the circumferential wall portion is mounted. The load input portion is formed in a spherical shape having a larger diameter than an inner diameter of the through hole at at least a side of the load input portion facing the through hole, and a load of a detection target is inputted. The sensor is disposed at the disc-shaped portion so as to be point-symmetrical to the through hole, and detects a distortion in response to a load inputted to the load input portion.

A braking apparatus of a vehicle disclosed in Patent reference 2 generates a braking torque at a wheel by pressing a frictional member to a rotary member fixed at the wheel of the vehicle via an electric motor. The electric braking apparatus of the vehicle includes a pressing member, a shaft member, a first spherical surface member, a second spherical surface member, an obtaining means, and a control means. The pressing member includes one of screw portions of a nut corresponding portion and a bolt corresponding portion, and applies a pressing force to a friction member. The shaft member is driven to rotate by an electric motor and threaded onto a screw portion. The first spherical surface member receives an opposing force of a pressing force from one of the pressing member and the shaft member, and is formed with a spherical surface at an end surface. The second spherical surface member is restricted from rotating relative to a rotary shaft of the shaft member, slidably conies in contact with a spherical surface of the first spherical surface member, and receives the opposing force of the pressing force from the first spherical surface member. The obtaining means detects the distortion of the second spherical surface member and obtains the pressing force in response to the distortion. The control means controls the electric motor in response to the pressing force.

A load detecting apparatus disposed in Patent reference 3 is configured with a load input portion, a disc-shaped disc-shaped portion, and a support member. The load input portion includes an input surface inputted with a load from a detection target and a curved-surface shaped output surface formed at an opposite side of the input surface, and outputs a load from the output surface. The disc-shaped disc-shaped portion includes a contact portion being in contact with the curved surface of the load input portion at a continuous circular line or at a dotted circular line about a center of the load input portion. The support member supports the disc-shaped portion between the disc-shaped portion and the mounting surface. In the load detecting apparatus, a range of a diameter of the input surface is set in response to a diameter of the contact portion changing in response to the distortion of the disc-shaped portion in accordance with the input of the load.

### DOCUMENT OF PRIOR ART

### Patent Document

Patent document 1: JP2013-250161A

Patent document 2: JP2014-101960A

Patent document 3: JP2014-102155A

### OVERVIEW OF INVENTION

### Problem to be Solved by Invention

The technologies disclosed in Patent references 1 to 3 detect the distortion generated by the applied load when detecting the load. A component (for example, a strain body of, for example, the circumferential wall portion and the disc-shaped portion) that deforms in response to the load provided in Order to easily generate the distortion. These strain bodies may cause plastic deformation or breakage when a load beyond expectation is inputted. Furthermore, in order to make the sensitivity of an element (for example, a sensor) detecting the distortion maintain in a good state, the upper limit is set for the distortion to be detected. However, in a system actually using the load detecting apparatus is unintentionally inputted with a load that is beyond expectation, and a displacement of the strain body may occur more often than expected. If the strain body is, for example, plastically deformed or broken by such an input of the load, the position of the strain body on the system may not be maintained, the entire length of the system may change, and the system may not be functioned appropriately.

Accordingly, a load detecting apparatus that does not break even in a case where a load beyond expectation is inputted.

### Means for Solving Problem

The characteristic configuration of a load detecting apparatus according to the present invention includes a load input portion including an input surface to which a load is inputted and an output surface being formed to protrude to an opposite side of the input surface, a strain both including an annular portion provided with a contact portion being in contact with at least a part of the output surface, the strain body including a support portion supporting the annular portion so as to be swingable, a swing portion being provided at one of a radial-direction outer end portion and a radial-direction inner end portion of the annular portion, the swing portion swinging in accordance with an input of the load, an extending portion being provided at the other of the radial-direction outer end portion and the radial-direction inner end portion of the annular portion, the extending portion being continuously provided with the swing portion and extending from the support portion, a sensor being disposed at a back surface of a surface in which the contact portion arranged at the annular portion is provided, the sensor detecting a distortion in accordance with a load inputted to the load input portion, and a restriction portion, at a base end portion of the extending portion relative to the contact portion, the restriction portion restricting a deformation of the annular portion beyond a predetermined value in a ease where the load inputted to the load input portion is greater than a preset load.

According to the characteristic configuration, since the restriction portion does not activate in a case where the load inputted to the load input portion is lower than an expected load, the load may be inputted to the input surface of the load input portion. In this case, the load may be detected appropriately by the load detecting apparatus. On the other hand, in a case where the load inputted to the load input portion is beyond expectation, since the load detecting apparatus may restrict the annular portion from deforming excessively, the plastic deformation or the breakage of, for example, the annular portion may be prevented.

In addition, it is favorable that the output surface of the load input portion is formed on a curvature surface and protrudes to the opposite side of the input surface, the annular portion is formed in a disc shape having an opening, and the support portion is formed in a cylindrical shape supporting the extending portion.

According to the configuration, since the support portion formed in a cylindrical shape may contain the annular portion and a part of the load input portion, the load detecting apparatus may be compactly configured. In addition, since the sensor may be contained in the support portion, the sensor may be protected.

Further, it is favorable that the restriction portion is formed at the support portion.

According to this configuration, in a case where the load beyond expectation is applied, the support portion may absorb the load beyond expectation and may prevent the load from applying to the annular portion.

Furthermore, it is favorable that at least one of a first contact surface and a second contact surface is formed in a spherical surface shape, the first contact surface including a first contact portion in which the restriction portion comes in contact with the load input portion, the second contact surface including a second contact portion in which the load input portion comes in contact with the restriction portion.

According to the aforementioned construction, since at least one of the first and second contact surfaces is formed in a spherical surface shape, the load input portion may prevent the load from inputting unevenly even in a case where, for example, the load input portion is inclined relative to the annular portion.

In addition, it is favorable that a center of curvature of a portion of the output surface, the portion being in contact with the contact portion, and a curvature center of a spherical surface shape portion formed in the spherical surface shape are set on an axis of the load input portion.

In the load detecting apparatus of the present configuration, in a case where the shape of the load input portion is focused, when seeing from a cross sectional view in which the annular portion including the axis of the annular portion is cut in a flat surface, the center of curvature of the portion of the output surface, the portion being in contact with the contact portion, is provided on the axis of the annular portion. This configuration may be obtained by forming, for example, a portion of the annular portion of the output surface, the portion being in contact with the contact portion, with a single spherical surface. A center of curvature in this case is set only one on the axis of the annular portion, and the attitude of the load input portion may easily change in a case where the load is inputted.

Here, in a case where the load inputted is beyond expectation, the restriction portion is required to function appropriately even if the attitude of the load input portion changes. In a case where the load is beyond expectation, a part of the load input portion comes in contact with the restriction portion formed at the support portion. Although the portion of the load input portion coming in contact with the restriction portion is formed at an entire circumference of the load input portion, it is desirable that the clearance between the portion and the restriction portion does not change as much as possible even in a case where the attitude of the load input portion changes. If so, in a case where the load input portion comes in contact with the restriction portion, the portion of the entire circumference comes in contact with the restriction portion evenly, and then, the attitude of the load input portion does not change excessively. That is, the annular portion and the swing portion do not deform partially, and the load detection apparatus may be securely protected.

As such, even in a case where the attitude of the load input portion changes, it is favorable that the center of curvature of the spherical surface shaped portion is positioned on the axis of the contact portion as the present configuration. As such, the length of the radius of curvature of the spherical surface shaped portion is not excessively short, and the great difference does not occur when compared to the radius of curvature of the portion of the output surface, the portion coming in contact with the contact portion. As a result, even in a case where the posture of the load input portion changes, the change of the distance between the load input portion and the restriction portion may be inhibited, and the favorable restriction effect may be provided even in a case where the load beyond expectation is acted.

Further, it is favorable that the restriction portion corresponds to a protrusion formed at the support portion.

According to this configuration, the load may be controlled at a preset position of the load input portion. Thus, the breakage of the load detecting apparatus may be prevented.

Furthermore, it is favorable that the swing portion is formed so as to be thinner in thickness towards an inner side in a radial direction from a borderline between the swing portion and the extending portion.

According to this configuration, the swing portion may easily distort in accordance with the load inputted to the load input portion. Accordingly, in a case where, for example, the sensor is mounted on the back surface of the swing portion, the distortion may easily detect by the sensor.

### BRIEF DESCRIPTION OF DRAWINGS

FIG. 1 is a view illustrating a side cross-section of a load detecting apparatus;

FIG. 2 is an exploded perspective view of the load detecting apparatus;

FIG. 3 is a view of the load detecting apparatus seen from bottom;

FIG. 4 is a circuit view illustrating a connection state of sensors;

FIG. 5 is a view illustrating a state in which a restriction portion restricts an input of a load;

FIG. 6 is a view illustrating a load detecting apparatus of another embodiment;

FIG. 7 is a view illustrating a load detecting apparatus of still another embodiment; and

FIG. 8 is a view illustrating a load detecting apparatus of still further embodiment.

### MODE FOR CARRYING OUT THE INVENTION

A load detecting apparatus according to the present invention is configured with a function restricting an input of a load in a case where a load which is beyond expectation is inputted. Hereinafter, a load detecting apparatus 1 of an embodiment will be explained.

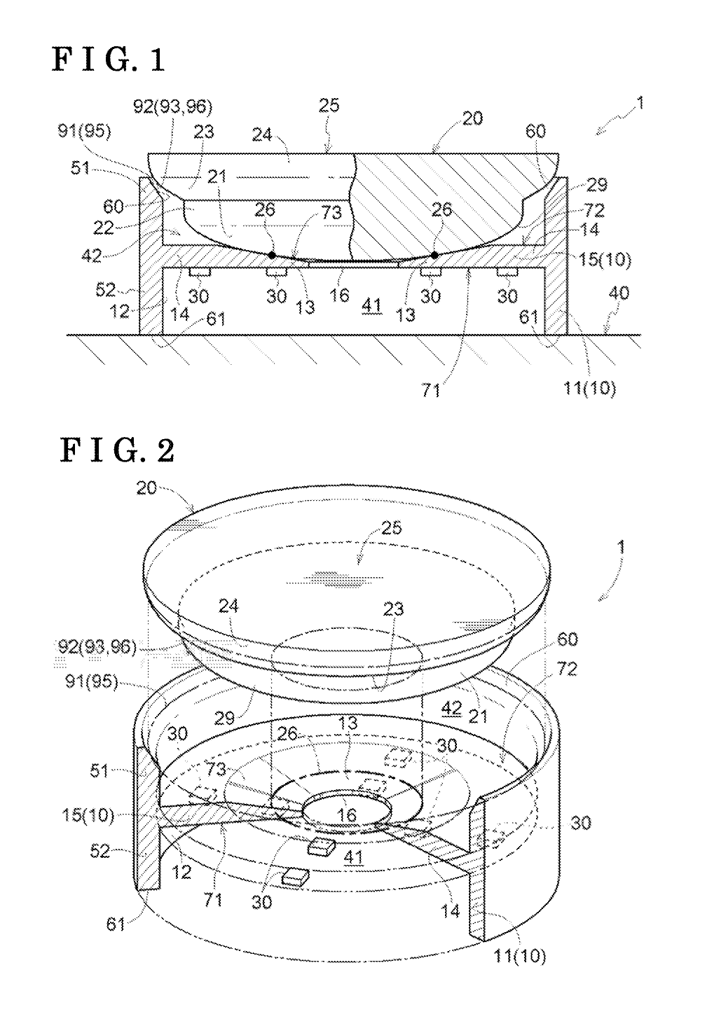

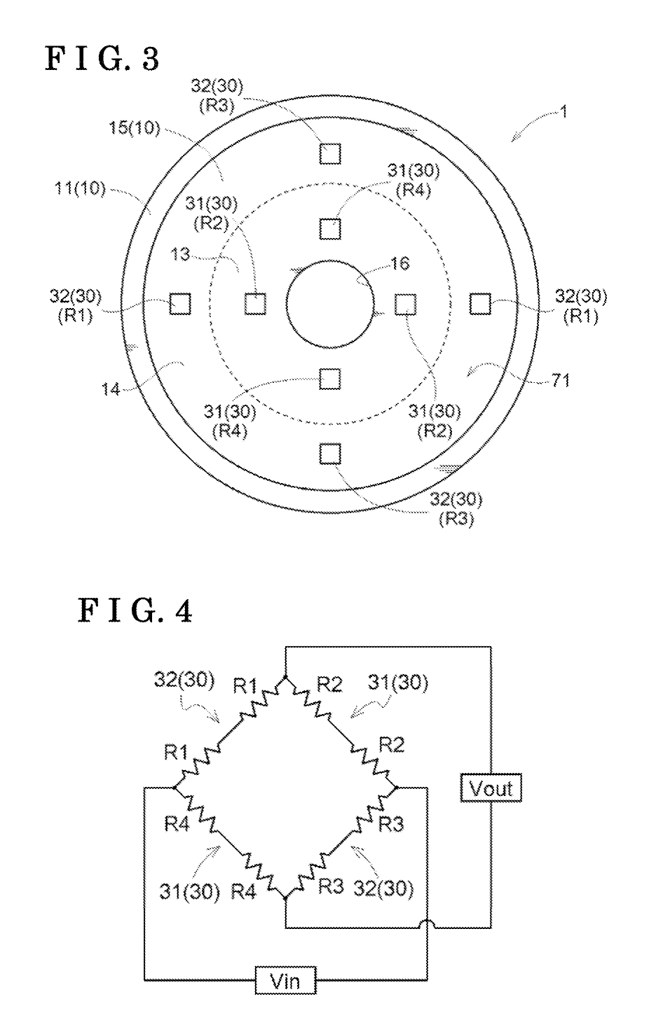

FIG. 1 illustrates a side cross-section view of the load detecting apparatus 1 according to the embodiment. FIG. 2 illustrates an exploded perspective view in which a part of the load detecting apparatus 1 is sectioned. FIG. 3 is a schematic view of the load detecting apparatus 1 seen from bottom. As illustrated in FIGS. 1 and 2, the load detecting apparatus 1 includes a strain body 10, a load input portion 20, and a sensor 30. The strain body 10 is configured with a support portion 11 and an annular portion 15.

The load input portion 20 includes an input surface 25 to which a load is inputted and a curved-surface shaped output surface 29 formed at an opposite side of the input surface 25. In the embodiment, the load input portion 20 is configured with four parts which are a first part 21, a second part 22, a third part 23, and a four part 24.

The first part 21 has a shape of, for example, an object having a smaller volume in a case where, for example, a sphere is cut at a position displaced from a center, or an object having a smaller volume in a case where an ellipse sphere is cut in parallel with a longitudinal axis at a position displaced from a center. The second part 22 includes a columnar portion that is in an engaged state with first part 21 at a cutting plane in a case where the first part 21 is cut. The third part 23 includes a similar shape as the first portion 21, and includes a larger outer diameter than an outer diameter of the first part 21 to sandwich the second part 22 between the first part 21 and the third pan 23. The fourth part 24 is formed with a columnar object so as to sandwich the third part 23 between the second part 22 and the fourth part 24. The outer diameter of the second part 22 is formed to match the outer diameter of the first part 21, and to include the outer diameter that is smaller than an inner diameter of the support portion 11. An outer diameter of the fourth part 24 is formed to match an outer diameter (the maximum diameter) of the third part 23, and to include the outer diameter that is larger than the inner diameter of the support portion 11. The load input portion 20 is configured such that the first part 21 and the second part 2 are containable in a space 42, and at least one part of the third part 23 and the fourth part 24 is disposed out of the space 42.

In the embodiment, the first part 21, the second part 22, the third part 23, and the fourth part 44 are integrally molded by, for example, a metal material. In the load input portion 20, the input surface 25 is set at a back side of a surface of the fourth part 24 where the third part 23 is provided. The output surface 29 is set at a back side of a surface of the first part 21 where the second part 22 is provided. Thus, the output surface 29 is formed on a curved surface by protruding opposite to the input surface 25. The output surface 29 is configured such that at least a part of the output surface 29 is in contact with the annular portion 15 that will be described later, and the load inputted to the input surface 25 is outputted to the annular portion 15.

The annular portion 15 is formed in an annular shape and includes a contact portion 26 being in contact with at least a part of the output surface 29 of the load input portion 20 at an annular line. In the embodiment, the annular portion 15 is formed in a disc shape including an opening. That is, a through hole 16 penetrating the annular portion 15 in an axial direction is formed at a center portion of the annular portion 15. In the annular portion 15, an outer circumferential surface of the annular portion 15 is in contact and fixed to an inner circumferential surface 12 of the support portion 11. In this case, it is favorable that the support portion 11 and the annular portion 15 are fixed such that the load applied to the annular portion 15 is not attenuated when being transmitted to the support portion 11.

It is favorable that the support portion 11 and the annular portion 15 are integrally formed by using a deformable material by receiving a load, for example, ceramic, aluminum, and stainless. However, if the load applied to the annular portion 15 is not attenuated when being transmitted to the support portion 11, the support portion 11 and the annular portion 15 may be formed separately.

The annular portion 15 includes a swing portion 13 and an extending portion 15. The swing portion 13 is provided at one of an outer end portion and an inner end portion of the annular portion 15 in a radial direction, and swings in response to an input of a load to the load input portion 20. In the embodiment, as described above, the through hole 16 is formed at the center portion of the annular portion 15, and the annular portion 15 is formed in a disc shape. Thus, in the embodiment, the swing portion 13 corresponds to a radial-direction inner part of the annular portion 15.

The extending portion 14 is disposed at the other of a radial-direction outer end portion and a radial-direction inner end portion of the annular portion 15, continuously provided with the swing portion 13, and extends from the support portion 11. In the embodiment, as described above, the swing portion 13 corresponds to the radial-direction inner part of the annular portion 15, and the extending portion 14 corresponds to radial-direction outer part of the annular portion 15. Thus, the extending portion 14 is provided over the support portion 11 and the swing portion 13.

The support portion 11 supports the annular portion 15 to be swingable. In the embodiment, the support portion 11 is formed in a cylindrical shape supporting the extending portion 14, and the annular portion 15 is supported at a predetermined position of a center portion of the support portion 11 in an axial direction. That is, the annular portion 15 is supported at an inner circumferential surface 12 of the support portion 11 so as to be away from both axial-direction end portions of the support portion 11. Accordingly, the support portion 11 is configured to include a clearance between the annular portion 15 and a mounting surface 40 in a case of being mounted on the mounting surface 40 while making one of the axial-direction end portions of the supporting portion 11 as a bottom portion. Accordingly, in a case where the support portion 11 that is provided opposite to the mounting surface 40 relative to the annular portion 15 corresponds to a first support portion 51 and the support portion 11 that is provided at the mounting surface 40 relative to the annular portion 15 corresponds to a second support portion 52, a clearance 41 is provided by the second support portion 52, the annular portion 15, and the mounting surface 40. Meanwhile, a clearance 42 is provided by an axial direction end surface of the first support portion 51, the first support portion 51, and the annular portion 15.

As illustrated in FIG. 3, the swing portion 13 and the extending portion 14 are continuously provided in the radial direction. In the embodiment, the extending portion 14 is formed so as to include a uniform thickness. On the other hand, the swing portion 13 is formed so as to be thinner in thickness towards an inner side in the radial direction. As described above, a radial-direction center portion of the annular portion 15 is formed with the through hole 16. Accordingly, the swing portion 13 is formed so as to be gradually thinner toward the through hole 16 from a borderline between the swing portion 13 and the extending portion 14 (a part shown with a dotted line in FIG. 3). In the embodiment, as shown in FIG. 1, in a case where the annular portion 15 is seen from an outer side in the radial direction, the swing portion 13 and the extending portion 14 are formed such that a surface 71 of the annular portion 15, the surface facing the mounting surface 40 is flat, and such that a tapered portion 73 is provided at an inner side of a surface 72 in the radial direction opposite to the surface 71 of the annular portion 15, the surface 71 facing the mounting surface 40.

In the embodiment, the load input portion 20 is mounted on the tapered portion 73. Accordingly, the load input portion 20 is in contact with the tapered portion 73 at a circular annular line without passing through the through hole 16. That is, the load input portion 20 can linearly contact with the tapered portion 73 annularly. Apart that linearly contacts with the tapered portion 73 corresponds to a contact portion 26. In FIG. 2, the contact portion 26 is shown with a chain line.

As shown in FIG. 3, the sensors 30 are disposed at the annular portion 15 so as to be point symmetry to the through hole 16 when the annular portion 15 is seen in the axial direction. In the embodiment, the sensor 30 is configured by a known distortion detection element. Although a detailed explanation will be omitted, a resistance value of the distortion detection element changes by the distortion of the distortion detection element in response to the load inputted from an outer side. The distortion may be detected based on the change of the resistance value. The sensor 30 is disposed at the surface 71 serving as a back surface of the surface 72 in which the contact portion 26 of the annular portion 15 is provided. Accordingly, the annular portion 15 is bent and deformed in response to the load inputted to the load input portion 20, and the distortion occurs at the sensor 30 by the deformation of the annular portion 15. The load detecting apparatus I detects the load by detecting the distortion generated at the sensor 30.

In the embodiment, the sensor 30 is configured by plural sensors and comprises a first sensor group 31 and a second sensor group 32. In the embodiment, the first sensor group 31 and the second sensor group 32 are also configured by the plural sensors 30.

The sensors 30 are equally disposed at a periphery of the through hole 16 in a circumferential direction so that the sensing direction of the first sensor group 31 corresponds to the circumferential direction of the annular portion 15. In the embodiment, the first sensor group 31 includes the four sensors 30. The four sensors 30 are equally disposed about the through hole 16, that is, are disposed to be displaced by ninety degrees, or 90 degrees about an axis of the annular portion 15 as a rotary shaft.

Accordingly, in a case where the load input portion 20 is applied with an outer force, the swing portion 13 bends downward. Here, a tensile force is applied to the swing portion 13 along the circumferential direction of the through hole 16. Thus, the first sensor group 31 mainly detects the tensile distortion.

In addition, the second sensor group 32 is equally disposed at the periphery of the through hole 16 in the circumferential direction such that the sensing direction of the second sensor group 32 corresponds to the radial direction of the annular portion 15. In the embodiment, the second sensor group 32 includes the four sensors 30. The four sensors 30 are equally disposed about the through hole 16, that is, are disposed to be displaced by 90 degrees about the axis of the annular portion 15 serving as the rotary shaft.

Accordingly, in a case where the load input portion 20 is applied with the outer force, the swing portion 13 bends downward. Here, the extending portion 14 is bent, and a compressive force is applied at the back surface of the extending portion 14. Thus, the second sensor group 32 mainly detects the compressive distortion.

The first sensor group 31 and the second sensor group 32 are disposed such that the first sensor group 31 is disposed at the inner side of the sensor group 32 in the radial direction.

In the embodiment, the sensor 30 is configured by using a known distortion detection element. In the embodiment, two distortion detection elements facing each other in the radial direction of the four distortion detection elements comprising each of the first and second sensor groups 31, 32 form the Wheatstone Bridge Circuit by being serially connected with each other as shown in FIG. 4. The Wheatstone Bridge Circuit is configured to increases the resistance value in a case where the tensile force is applied to the distortion detection element, and to decrease the resistance value in a case where the compressive force is applied to the distortion detection element. The change of the resistance value is calculated by the change of the voltage or the current, and the load is detected. Since the distortion detection element and the Wheatstone Bridge Circuit are well known, the explanation thereof will be omitted. Furthermore, in FIGS. 3 and 4, reference numerals R1 to R4 are embedded for the distortion detection elements in order to facilitate the understanding of the disposition of the distortion detection elements of the first and second sensor groups 31, 32.

By the configuration of the load detecting apparatus 1 the first sensor group 31 is applied with the tensile distortion and the second sensor group 32 is provided with the compressive distortion in a case where the load is applied to the load input portion 20. Thus, the load may be detected sensitively.

Here, as shown in FIGS. 1 and 2, the load detecting apparatus 1 is formed with a restriction portion 60 at the support portion 11 so that, specifically, the strain body 10 is not plastic-deformed or broken in a case where the load beyond expectation is inputted. The restriction portion 60 is formed at a base end portion of the extending portion 14 relative to the contact portion 26. The contact portion 26 corresponds to a part (position) where the load input portion 20 and the annular portion 15 are in contact with each other. The base end portion of the extending portion 14 corresponds to a part of the extending portion 14 disposed at a side where the support portion 11 supporting the extending portion 14 is provided, and the base end portion includes the support portion 11. Thus, the restriction portion 60 is formed at a part of the extending portion 14 close to the support portion 11 relative to the contact portion of the load input portion 20 and the annular portion 15.

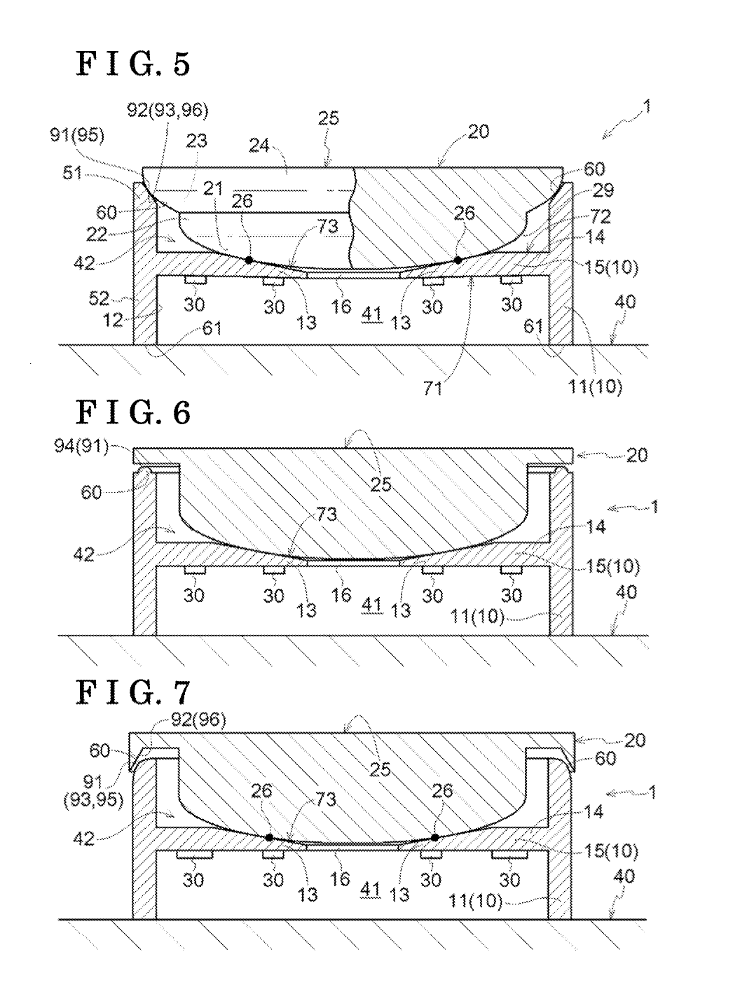

As illustrated in FIG. 1, the load detecting apparatus 1 is formed to include the clearance between the restriction portion 60 and the load input portion 20 until the load within expectation is inputted to the load input portion 20, and in a case where the load inputted to the load input portion 20 is greater than a preset load, the clearance between restriction portion 60 and the load input portion 20 disappears as shown FIG. 5, and the restriction portion 60 restricts the deformation of the annular portion 15, the deformation that is beyond the predetermined value. In other words, after the restriction portion 60 and the load input portion 20 come in contact with each other, the load inputted to the load input portion 20 is received at the support portion 11, and the output surface 29 cannot output the load only to the annular portion 15.

Further, in the embodiment, the restriction portion 60 is formed at a position facing a disposition portion 61 in which the mounting surface 40 mounted with the load detecting apparatus 1 is in contact with the support portion 11 along the direction in which the load is inputted. The disposition portion 61 in which the mounting surface 40 is in contact with the support portion 11 corresponds to an end surface of the end surfaces of the both sides of the support portion 11 in the axial direction, the end surface that is provided at a side where the second support portion 52 is provided. The direction to which the load is inputted corresponds to, in the embodiment, an axial direction of the support portion 11. Accordingly, the restriction portion 60 is provided at a side of the support portion 11 where the first support portion 51 is provided. In the embodiment, the restriction portion 60 is formed in a shape in which an inner circumferential rim portion of the first support portion 51 is cut in a tapered shape.

Furthermore, at least one of a first contact surface 95 and a second contact surface 96 is formed in a spherical surface shape. The first contact surface 95 includes a first contact portion 91 in which the restriction portion 60 comes in contact with the load input portion 20. The second contact surface includes a second contact portion 92 in which the load input portion 20 comes in contact with the restriction portion 60. Specifically, in the embodiment, as shown in FIG. 1, the first contact surface 95 includes a side-cross-sectional surface that is formed in a flat surface, and the second contact surface 96 is formed in a spherical surface shape. In addition, a center of curvature of a portion of the output surface 29, the portion being in contact with the contact portion 26, and a center of curvature of the spherical surface shape portion 93 formed in a spherical surface shape are set on an axis of the load input portion 20. By this configuration, a clearance between the load input portion 20 and the restriction portion 60 may not easily change even in a case where the load is unevenly inputted to the load input portion 20 and the attitude of the load input portion 20 changes. Thus, even in a case where the load beyond expectation is inputted to the load input portion 20, the deformation of the strain body 10 may be inhibited, and the plastic deformation or the breakage of the strain body 10 may be prevented.

### Other Embodiment

The aforementioned embodiment has been explained such that the first contact surface 95 is formed in a flat surface. Alternatively, as shown in FIG. 6, the restriction portion 60 may be formed as a protrusion 94 formed at the support portion 11. Even in this configuration, the input of the load that is beyond expectation may be restricted by the formation of the load detecting apparatus 1 such that the load input portion 20 comes in contact with the protrusion 94 in a case where the load beyond expectation is inputted to the load input portion 20.

In addition, the aforementioned embodiment has been explained such that the first contact surface 95 includes the side cross sectional surface being formed in a flat surface shape, and the second contact surface 96 is formed in a spherical surface shape have been explained. Alternatively, as shown in FIG. 7, the side cross sectional surface of the first contact surface 95 including the first contact portion 91 in which the restriction portion 60 is comes contact with the load input portion 20 may be formed in a spherical surface shape, and the second contact surface 96 including the second contact portion 92 in which the load input portion 20 comes in contact with the restriction portion 60 may be formed in a flat surface shape. Even in this case, a radius center of the spherical surface shape portion 93 formed in the spherical surface shape is set on the axis of the contact portion 26. Of course, the both of the first contact surface 95 and the second contact surface 96 may be formed in a flat surface shape that is in parallel with the input surface 25 of the load input portion 20 to form the restriction portion 60.

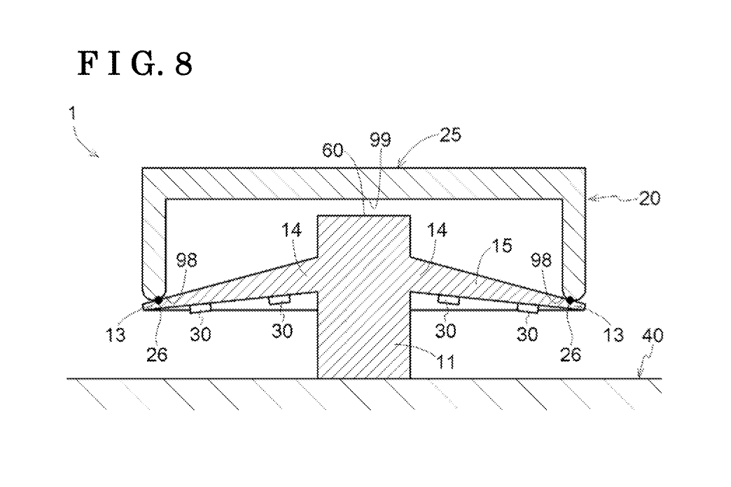

The above described embodiment has been explained such that the annular portion 15 is formed in a disc shape having the opening, and the support portion 11 is filmed in a cylindrical shape supporting the extending portion 14. Alternatively, as shown in FIG. 8, the support portion 11 may be formed in a columnar shape, and the annular portion 15 may be formed in an annular shape extending outwardly in the radial direction about the support portion 11 as an axis. In this case, since the load input portion 20 is formed in a cup shape, a cup-shaped rim portion 98 inputs the load to the annular portion 15, and in a case where the load beyond expectation is inputted, a cup-shaped bottom portion 99 and a distal end portion of the support portion 11 as the restriction portion 60 come in contact with each other. Furthermore, even in this case, the restriction portion 60 is formed at the base end portion of the extending portion 14 relative to the contact portion 26. Even in this configuration, in a case where the load inputted to the load input portion 20 is beyond expectation, the restriction portion 60 can restrict the load inputted to the input surface 25 of the load input portion 20.

The aforementioned embodiment has been explained such that the restriction portion 60 is formed at the support portion 11. Alternatively, the restriction portion 60 may be formed at the annular portion 15 as long as the restriction portion 60, the base end portion of the extending portion 14, and the contact portion 26 are aligned in the aforementioned order when seen from the restriction portion 60.

The aforementioned embodiment has been explained such that, at the cross sectional surface of the load input portion 20 that is cut in parallel to the axis of the annular portion 15 by including the axis thereof, the radius center of the spherical surface portion 93 formed in a spherical surface shape is set on the axis of the contact portion 26. Alternatively, the radius taxis of the spherical surface shape portion 93 formed in the spherical surface shape may he configured so as not to be set on the axis of the contact portion 26.

### INDUSTRIAL APPLICABILITY

The present invention may be used for a load detecting apparatus detecting a load.

### EXPLANATION OF REFERENCE NUMERALS

1: load detecting apparatus, 10: strain body, 11 support portion, 13: swing portion, 14: extending portion, 15: annular portion, 20: load input portion, 25: input surface, 26: contact portion, 29: output surface, 30: sensor, 60: restriction portion, 72: surface, 91: first contact portion, 92: second contact portion, 93: spherical surface shape portion, 94: protrusion, 95: first contact surface, 96: second contact surface

1. A load detecting apparatus, comprising:
a load input portion including an input surface to which a load is inputted and an output surface being formed to protrude to an opposite side of the input surface;
a strain body including an annular portion provided with a contact portion being in contact with at least a part of the output surface, the strain body including a support portion supporting the annular portion so as to be swingable;
a swing portion being provided at one of a radial-direction outer end portion and a radial-direction inner end portion of the annular portion, the swing portion swinging in accordance with an input of the load;
an extending portion being provided at the other of the radial-direction outer end portion and the radial-direction inner end portion of the annular portion, the extending portion being continuously provided with the swing portion and extending from the support portion;
a sensor being disposed at a back surface of a surface in which the contact portion arranged at the annular portion is provided, the sensor detecting a distortion in accordance with a load inputted to the load input portion; and
a restriction portion being formed at a base end portion of the extending portion relative to the contact portion, the restriction portion restricting a deformation of the annular portion beyond a predetermined value in a case where the load inputted to the load input portion is greater than a preset load.

2. The load detecting apparatus according to claim 1, wherein
the output surface of the load input portion is formed on a curvature surface and protrudes to the opposite side of the input surface;
the annular portion is formed in a disc shape having an opening; and
the support portion is formed in a cylindrical shape supporting the extending portion.

3. The load detecting apparatus according to claim 1, wherein
the restriction portion is formed at the support portion.

4. The load detecting apparatus according to claim 1, wherein at least one of a first contact surface and a second contact surface is formed in a spherical surface shape, the first contact surface including a first contact portion in which the restriction portion comes in contact with the load input portion, the second contact surface including a second contact portion in which the load input portion comes in contact with the restriction portion.

5. The load detecting apparatus according to claim 4, wherein a center of curvature of a portion of the output surface, the portion being in contact with the contact portion, and a curvature center of a spherical surface shape portion formed in the spherical surface shape are set on an axis of the load input portion.

6. The load detecting apparatus according to claim 1, wherein the restriction portion corresponds to a protrusion formed at the support portion.

7. The load detecting apparatus according to claim 1, wherein the swing portion is formed so as to be thinner in thickness towards an inner side in a radial direction from a borderline between the swing portion and the extending portion.
